(19) United States
(12) Patent Application Publication
(10) Pub. No.: US 2009/0288380 A1
(43) Pub. Date: Nov. 26, 2009

(54) FILTRATION STRUCTURE, IN PARTICULAR A PARTICULATE FILTER FOR THE EXHAUST GASES OF AN INTERNAL COMBUSTION ENGINE, AND ASSOCIATED EXHAUST LINE

(76) Inventors: Vincent Gleize, Avignon (FR); Anthony Briot, Avignon (FR); Patrick Girot, Avignon (FR); Sebastien Bardon, La Ciotat (FR)

Correspondence Address: SUGHRUE MION, PLLC, 2100 PENNSYLVANIA AVENUE, N.W., SUITE 800, WASHINGTON, DC, 20037, US

(21) Appl. No.: 11/721,084

(22) PCT Filed: Nov. 30, 2004
(86) PCT No.: PCT/FR05/02983

§ 371 Date: Aug. 17, 2007

(30) Foreign Application Priority Data
Jul. 12, 2004 (FR) 04113030

(51) Int. Cl. B01D 46/00

(52) U.S. Cl. 55/483

(57) ABSTRACT

Said structure comprises first and second filtering elements (15A, 15B) respectively comprising a first and second lateral surface (24A, 24B) disposed opposite each other. A joint (17) linking said surfaces (24A, 24B) extends between the surfaces (24A, 24B). The first lateral surface (24A) comprises, in the upstream part (36A), a first region (35C) of low or zero adherence with the joint (17), said region being defined longitudinally upstream by an upstream region (33A) of high adherence with said joint (17). The upstream region (33A) of high adherence is longitudinally defined upstream by a second region (35A) of low or zero adherence with the joint (17). Application: particle filters for the exhaust gases of an engine.

The present invention relates to a filtration structure, in particular a particulate filter for the exhaust gases of an internal combustion engine, of the type comprising:
at least first and second filtration elements, each filtration element having a gas inlet face and a gas discharge face which are connected to each other by at least two lateral faces, the first and the second filtration elements respectively having a first and a second lateral face which are arranged facing each other; and
a joint for connecting the faces, extending between the faces;

the first lateral face comprising, in the upstream half thereof, a first region of weak or zero adhesion to the joint, delimited longitudinally in an upstream direction by an upstream region of strong adhesion to the joint;

each region of weak or zero adhesion to the joint of the first face being located substantially facing a region of strong adhesion to the joint of the second face, and each region of strong adhesion to the joint of the first face being located substantially facing a region of weak or zero adhesion to the joint of the second face.

Structures of this type are used in particular in devices for depolluting the exhaust gases of internal combustion engines. These devices comprise an exhaust chamber which comprises in series a catalytic purification element and a particulate filter. The catalytic purification element is suitable for processing the polluting emissions in the gaseous phase, whilst the particulate filter is suitable for retaining the particles of soot discharged by the engine.

In a known structure of the above-mentioned type (FR-A-2 853 256), the filtration elements comprise an assembly of adjacent conduits having parallel axes separated by porous filtration walls. These conduits extend between the inlet face for the exhaust gases to be filtered and the discharge face for the filtered exhaust gases. These conduits are further blocked at one or other of the ends thereof in order to delimit inlet chambers which open at the inlet face and outlet chambers which open at the discharge face.

These structures operate in accordance with a succession of filtration and regeneration phases. During the filtration phases, the particles of soot discharged by the engine are deposited on the walls of the inlet chambers. The pressure drop through the filter increases progressively. Beyond a predetermined value for this pressure drop, a regeneration phase is carried out.

During the regeneration phase, the particles of soot, which are substantially composed of carbon, are burnt on the walls of the inlet chambers, using auxiliary heating means, in order to restore the original properties of the structure.

However, the combustion of soot in the filter is not carried out in a homogeneous manner. The combustion begins upstream and in the centre of the filter, then spreads. Temperature gradients appear in the filter during the regeneration phases.

The temperature gradients within the filtration structure produce local expansions of different amplitudes and consequently longitudinal and transverse stresses in and/or between the different filtration elements.

These high levels of thermomechanical stress result in fractures in the filtration elements and/or in the connection joints between these filtration elements.

In order to limit the risk of these fractures appearing, the application FR-A-2 853 256 mentioned above proposes creating, on the first and second faces, regions of weak or zero adhesion to the joint, in particular by applying an anti-adhesive coating in this region. The presence of these regions allows the thermomechanical stresses in the joint to be relaxed and, if the level of these stresses is too high, allows the propagation of any fractures which may occur in the joint to be guided along these regions.

The provision of regions of weak or zero adhesion to the joint further allows the filtration elements to be retained when the joint is fractured counter to the pressure of the exhaust gases which is applied to the inlet faces of the filtration elements.

The main object of the invention is to further improve the retention of the filtration elements counter to the pressure applied to one or more components of the filter during the steps for assembling the particulate filter in the exhaust line or the pressure of the exhaust gases when the filter is used.

To this end, the invention relates to a filtration structure of the above-mentioned type, characterised in that the upstream region of strong adhesion is delimited longitudinally in an upstream direction by a second region of weak or zero adhesion to the joint.

The filtration structure according to the invention may comprise one or more of the following features, taken in isolation or in accordance with any technically possible combination:
the second region of weak or zero adhesion to the joint extends as far as the inlet face;
the maximum length of the upstream region of strong adhesion to the joint is less than or substantially equal to the minimum length of the adjacent regions of weak or zero adhesion to the joint;
the maximum length of the upstream region is less than one fifth of the total length of the first filtration element;
one of the first and second lateral faces comprises, in the downstream half thereof, a downstream region of strong adhesion to the joint, delimited in an upstream and downstream direction by respective regions of weak or zero adhesion to the joint;
the region of weak or zero adhesion to the joint that is adjacent to the downstream region in a downstream direction extends as far as the discharge face;
the maximum length of the downstream region of strong adhesion to the joint is less than or substantially equal to the minimum length of the adjacent regions of weak or zero adhesion to the joint;
the downstream region extends over the first face;
one of the first and second lateral faces comprises, between the upstream region and the downstream region, at least an intermediate region of strong adhesion to the joint, and adjacent regions of weak or zero adhesion to the joint, located upstream and downstream of the intermediate region, respectively, and
the lengths of the downstream region, the upstream region and the intermediate region are substantially identical.

The invention also relates to an exhaust line, characterised in that it comprises a structure as defined above.

Exemplary embodiments of the invention will now be described with reference to the appended drawings, in which:

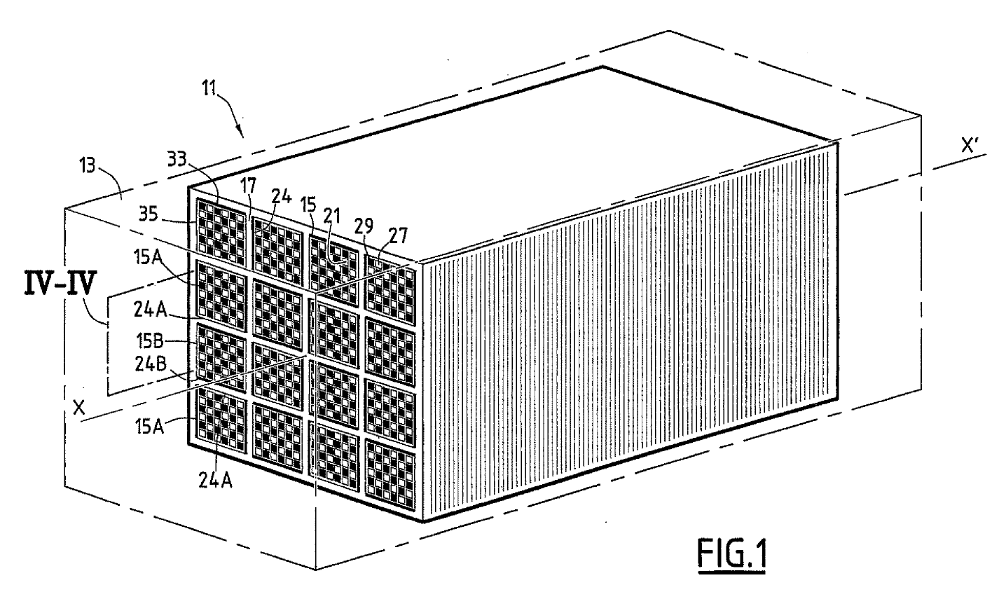

FIG. 1 is a perspective view of a first filtration structure according to the invention;

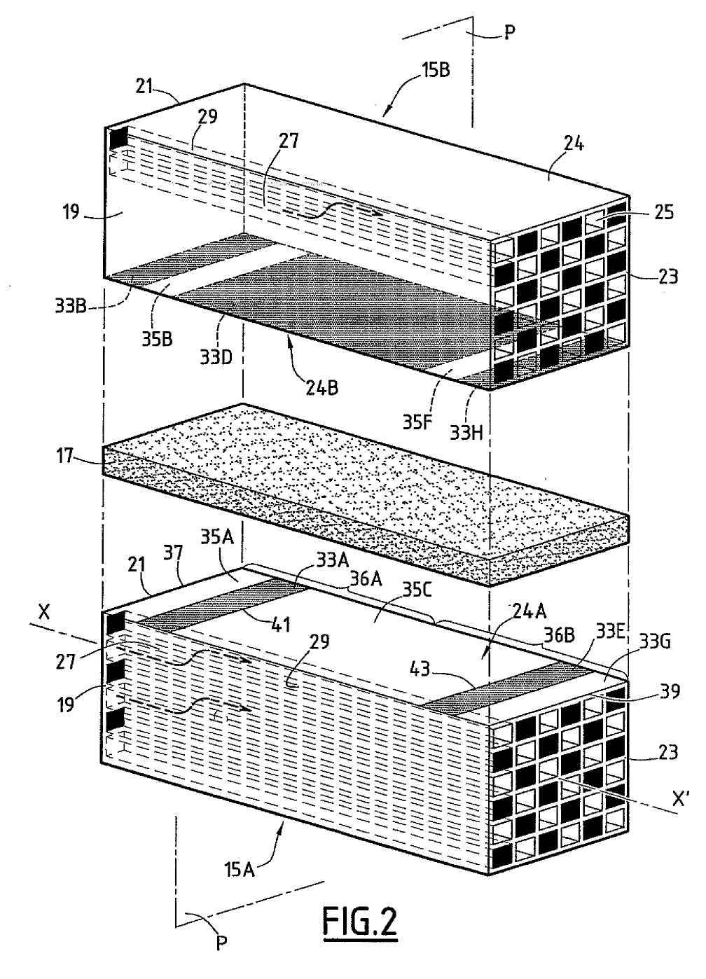

FIG. 2 is a partial exploded perspective view of the filtration structure of FIG. 1;

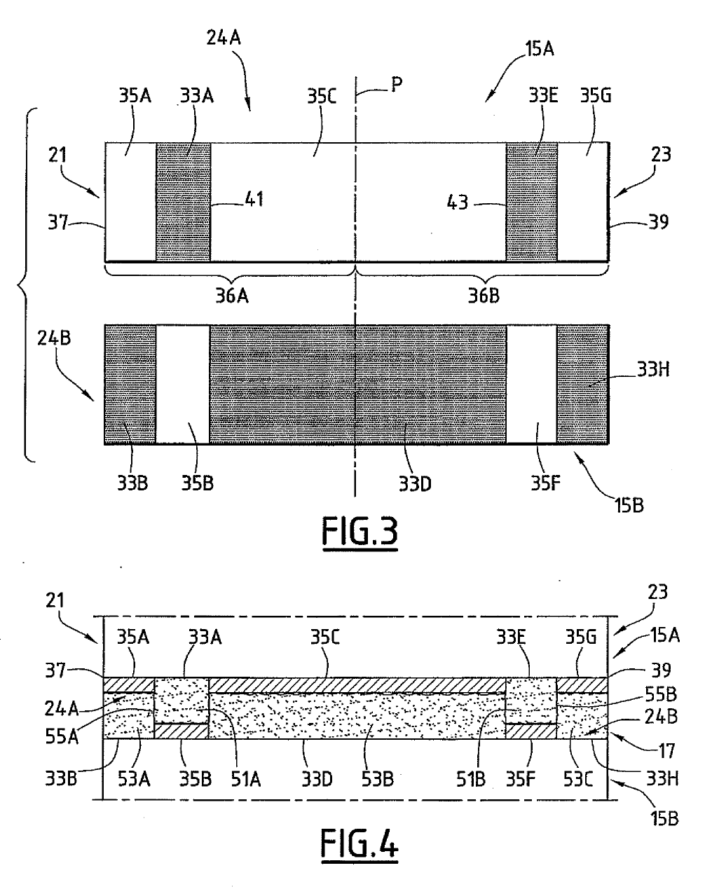

FIG. 3 is a plan view of two faces facing each other of the filtration elements of FIG. 2;

FIG. 4 is a partial view, sectioned along the longitudinal plane IV-IV of FIG. 1, of the first filtration structure after several regeneration cycles of the filtration structure;

FIG. 5 is a view similar to FIG. 3, of a second filtration structure according to the invention;

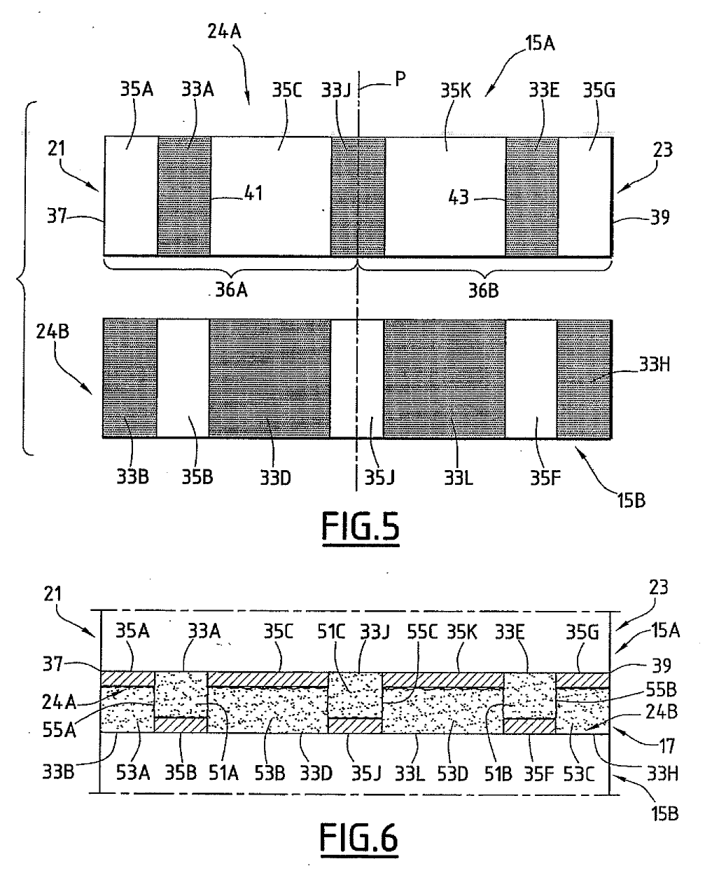

FIG. 6 is a view similar to FIG. 4 of the second filtration structure according to the invention;

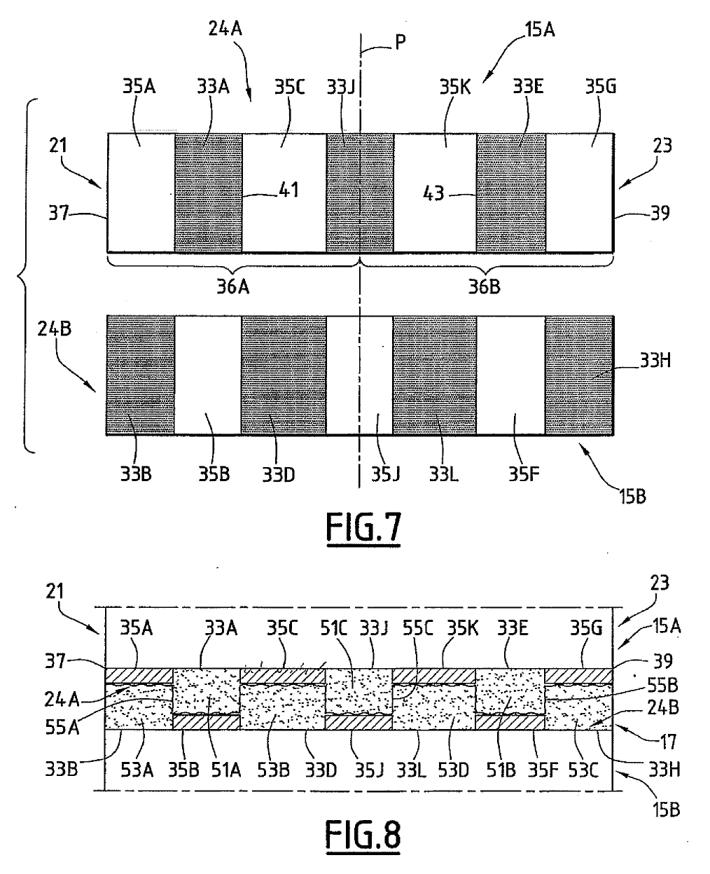

FIG. 7 is a view similar to FIG. 3 of a third filtration structure according to the invention; and

FIG. 8 is a view similar to FIG. 4 of the third filtration structure according to the invention.

The particulate filter 11 illustrated in FIG. 1 is arranged in an exhaust line 13 for the gases of a motor vehicle diesel engine, partially illustrated.

This exhaust line 13 extends beyond the ends of the particulate filter 11 and delimits a passage for circulation of the exhaust gases.

The particulate filter 11 extends in a longitudinal direction X-X′ for circulation of the exhaust gases. It comprises a plurality of filtration units 15 which are connected to each other by means of connection joints 17.

Each filtration unit 15 has a substantially parallelepipedal elongate rectangular form in the longitudinal direction X-X′.

The term “filtration unit” more generally refers to an assembly which comprises an inlet face, a discharge face, and at least two lateral faces (four lateral faces in the example illustrated) which connect the inlet face to the discharge face.

As illustrated in FIG. 2, each filtration unit 15A, 15B comprises a porous filtration structure 19, an inlet face 21 for the exhaust gases to be filtered, a face 23 for discharging the filtered exhaust gases, and four lateral faces 24.

The porous filtration structure 19 is produced from a filtration material which is constituted by a monolithic structure, in particular of ceramic material (cordierite, silicon carbide, etc.).

This structure 19 has a sufficient level of porosity to allow the passage of exhaust gases. However, as known per se, the diameter of the pores is selected to be sufficiently small to retain the particles of soot (between 5 and 100 micrometres).

The porous structure 19 comprises an assembly of adjacent conduits having axes which are parallel with the longitudinal direction X-X′. These conduits are separated by porous filtration walls 25. In the example illustrated in FIG. 2, these walls 25 have a constant thickness and extend longitudinally in the filtration structure 19, from the inlet face 21 to the discharge face 23.

The conduits are divided into a first group of inlet conduits 27 and a second group of outlet conduits 29. The inlet conduits 27 and outlet conduits 29 are arranged in a mutually transposed manner.

The inlet conduits 27 are blocked in the region of the discharge face 23 of the filtration unit 15A, 15B and are open at the other end thereof.

Conversely, the outlet conduits 29 are blocked in the region of the inlet face 21 of the filtration unit 15A, 15B and open along the discharge face 23 thereof.

In the example illustrated in FIG. 1, the inlet conduits 27 and outlet conduits 29 have cross-sections which are constant over the entire length thereof.

As illustrated in FIG. 2, the lateral faces 24A and 24B of the opposing units 15A and 15B are planar.

As illustrated in FIGS. 2 and 3, each planar face 24A, 24B of a filtration unit located opposite another unit comprises at least one region 33 which is fixedly joined to the joint 17, and at least one region 35 which, when the structure 19 is produced, is covered with an anti-adhesive coating. This coating is based, for example, on paper, polytetrafluoroethylene, polyethylene, polypropylene, graphite or boron nitride.

The adhesion between the connection joint 17 and the planar faces 24 of the filtration units 15 in the regions 33 of strong adhesion to the joint is at least 10 times greater than that of the regions 35 of weak or zero adhesion to the joint 17. The adhesion of the regions 35 of weak or zero adhesion to the joint 17 is between 0 and 50 MPa.

In the following text, “region of strong adhesion” is intended to refer to a region 33 of strong adhesion to the joint 17 and “region of weak adhesion” is intended to refer to a region 35 of weak or zero adhesion to the joint 17.

The arrangement of the regions 33 and the regions 35 on the planar faces 24 of the filtration units 15 is illustrated in FIGS. 2 and 3.

The first face 24A of the first filtration unit 15A comprises, in the upstream half 36A thereof located upstream of a transverse centre plane P, an upstream region 33A of strong adhesion, delimited in a downstream direction, at the righthand side in the Figures, by a first region 35C of weak adhesion which extends at one side and the other of the plane P.

The upstream region 33A is further delimited in an upstream direction, at the left-hand side in the Figures, by a second region 35A of weak adhesion which extends as far as the edge 37 common to the inlet face 21 and the first face 24A.

The first face 24A further comprises, in the downstream half 36B thereof, a downstream region 33E of strong adhesion which is delimited in an upstream direction by the first region 35C of weak adhesion, and which is delimited in a downstream direction by a third region 35G of weak adhesion which extends as far as the edge 39 common to the discharge face 23 and the first face 24A.

The regions 33 of strong adhesion and regions 35 of weak adhesion are substantially rectangular and extend transversely over the entire width of the first face 24A.

In the remainder of the text, the lengths are taken to be parallel with the longitudinal direction X-X′.

The length of the upstream region 33A is substantially less than one quarter of the total length of the first filtration unit 15A. In the example illustrated, the ratio of the length of the upstream region 33A to the total length of the unit 15A is between 0.10 and 0.15.

In this example, the length of the upstream region 33A is less than the length of the first region 35C of weak adhesion and substantially equal to the length of the second region 35A of weak adhesion.

In this manner, the distance between the downstream edge 41 of the upstream region 33A and the edge 37 is less than one half of the total length of the unit 15A. The upstream region 33A is therefore located in the region of the inlet face 21.

The total length of the first region 35C of weak adhesion is greater than one half of the total length of the unit 15A so that the distance between the downstream edge 41 of the upstream region 33A and the upstream edge 43 of the downstream region 33E is greater than one half of the total length of the unit 15A.

The length of the downstream region 33E is substantially equal to the length of the upstream region 33A and the length of the third region 35G of weak adhesion.

Each region 33A, 33E of strong adhesion of the first face 24A is arranged substantially facing a region 35B, 35F of weak adhesion which has a substantially identical shape on the second face 24B.

Furthermore, each region 35A, 35C, 35G of weak adhesion of the first face 24A is located facing a region 33B, 33D, 33H of strong adhesion which has a substantially identical shape on the second face 24B.

The operation of the first filtration structure according to the invention will now be described.

During a filtration phase (FIG. 1), the exhaust gases which are loaded with particulates, are guided as far as the inlet faces 21 of the filtration units 15 by the exhaust line 13. As indicated by arrows in FIG. 2, they then enter the inlet conduits 27 and pass through the walls 25 of the porous structure 19. During this passage, the soot is deposited on the walls 25 of the inlet conduits 27. This soot is preferably deposited in the region of the centre axis of the particulate filter 11 and towards the discharge face 23 of the filtration units 15 (at the right-hand side in the drawings).

The filtered exhaust gases are discharged via the discharge conduits 29 and are guided to the outlet of the exhaust chamber.

When the vehicle has travelled approximately 500 km, the pressure drop through the filter 11 increases significantly. A regeneration phase is then carried out.

In this phase, the soot is oxidised by increasing the temperature of the filter 11. This oxidation is exothermic and begins at the centre and upstream of the filter. This therefore brings about a temperature gradient between the upstream and downstream portions and between the periphery and centre of the filter.

Furthermore, the filtration units 15 and the joints 17 expand under the effect of the temperature. The local extent of this expansion is dependent on the temperature.

These variations in the extent of expansion, under the effect of the temperature gradients, bring about significant levels of thermomechanical stress. The presence of regions 35 of weak adhesion allows the stresses to be relaxed and allows the formation of fractures to be prevented in the filtration units 15 or in the connection joints 17.

Furthermore, as illustrated in FIG. 4, if the levels of thermomechanical stress are too great for the structure, the joint 17 may fracture longitudinally. However, the regions 35 of weak adhesion and the regions 33 of strong adhesion are arranged in such a manner that the fracturing occurs in preferred zones.

In this manner, as illustrated in FIG. 4, the propagation of the fractures in the joints 17 is guided along the regions 35 of weak adhesion on the planar faces 24 of the filtration units 15 and transversely between these regions.

Consequently, even if the joint 17 is completely fractured, the portion 51A of the joint located facing the upstream region 33A forms a parallelepipedal upstream projection which is fixedly joined to the first unit 15A. Furthermore, the portions 53A and 53B of the joint, which are arranged facing the regions 35A and 35C of weak adhesion, respectively, remain fixedly joined to the second unit 15B. These portions 53A and 53B delimit a hollow upstream notch 55A which receives the projection 51A.

In this manner, even if the joint 17 is completely fractured, the co-operation between the upstream projection 51A and the upstream notch 55A prevents the downstream movement of the units 15A and 15B, counter to the pressure of the exhaust gases which is applied to the inlet faces 21.

The upstream projection 51A and the upstream notch 55A extend in the region of the inlet face 21, facing upstream portions of the units 15A, 15B, in which the levels of thermal stress are relatively low. Consequently, the filtration units 15A, 15B are retained in an efficient manner, even if the downstream portions of these units 15A, 15B which are subject to high levels of thermal stress, have become damaged.

Furthermore, the portion 51B of the joint located opposite the downstream region 33E of the first face 24A forms a downstream projection which is fixedly joined to the first unit 15A. The downstream projection 51B co-operates with a hollow downstream notch 55B which is delimited by joint portions 53B, 53C which extend facing the regions 35C and 35G of weak adhesion, the portions 53B and 53C remaining fixedly joined to the second face 24B.

Consequently, if the downstream portions of the units 15A, 15B are not damaged, the co-operation between the downstream projection 51B and the downstream notch 55B also contributes to retaining the units 15A and 15B.

The filter 11 illustrated in FIGS. 5 and 6 differs from that illustrated in FIG. 5 owing to the following features.

The first face 24A comprises an intermediate region 33J of strong adhesion located substantially half-way along the first face 24A.

This region 33J has a length which is substantially equal to that of the upstream region 33A and downstream region 33E. The length of the region 33J is further less than that of the adjacent regions 35C and 35K of weak adhesion.

During operation, if the joint 17 fractures, the portion 51C of the joint located opposite the intermediate region 33J forms an intermediate projection. This projection 51C co-operates with a hollow intermediate notch 55C which is delimited by the joint portions 53B and 53D which are fixedly joined to the second face 24B and are located respectively opposite the regions 35C, 35K of weak adhesion adjacent to the intermediate region 33J.

The filter 11 illustrated in FIGS. 7 and 8 differs from the filter illustrated in FIGS. 5 and 6 in that the ratio of the length of the upstream region 33A relative to the length of the second region 35C of weak adhesion is greater than 0.6.

In this example, the ratio is substantially equal to 0.75.

In a variant, the downstream region 33E of strong adhesion, which has a length substantially equal to the upstream region 33A, extends over the second face 24B.

1. Filtration structure (11), in particular a particulate filter for the exhaust gases of an internal combustion engine, of the type comprising:
at least first and second filtration elements (15A, 15B), each filtration element (15A, 15B) having a gas inlet face (21) and a gas discharge face (23) which are connected to each other by at least two lateral faces (24), the first and the second filtration elements (15A, 15B) respectively having a first and a second lateral face (24A, 24B) which are arranged facing each other; and
a joint (17) for connecting the faces (24A, 24B), extending between the faces (24A, 24B);
the first lateral face (24A) comprising, in the upstream half (36A) thereof, a first region (35C) of weak or zero adhesion to the joint (17), delimited longitudinally in an upstream direction by an upstream region (33A) of strong adhesion to the joint (17);
each region (35) of weak or zero adhesion to the joint (17) of the first face (24A) being located substantially facing a region (33) of strong adhesion to the joint (17) of the second face (24B), and each region (33) of strong adhesion to the joint (17) of the first face (24A) being located substantially facing a region (35) of weak or zero adhesion to the joint (17) of the second face (24B);
characterised in that the upstream region (33A) of strong adhesion is delimited longitudinally in an upstream direction by a second region (35A) of weak or zero adhesion to the joint (17).

2. Structure (11) according to claim 1, characterised in that the second region (35A) of weak or zero adhesion to the joint (17) extends as far as the inlet face (21).

3. Structure (11) according to claim 1, characterised in that the maximum length of the upstream region (33A) of strong adhesion to the joint (17) is less than or substantially equal to the minimum length of the adjacent regions (35A, 35C) of weak or zero adhesion to the joint.

4. Structure (11) according to claim 1, characterised in that the maximum length of the upstream region (33A) is less than one fifth of the total length of the first filtration element (15A).

5. Structure (11) according to claim 1, characterised in that one of the first and second lateral faces (24A, 24B) comprises, in the downstream half (36B) thereof, a downstream region (33E) of strong adhesion to the joint (17), delimited in an upstream and downstream direction by respective regions (35C; 35K, 35G) of weak or zero adhesion to the joint (17).

6. Structure (11) according to claim 5, characterised in that the region (35G) of weak or zero adhesion to the joint (17) that is adjacent to the downstream region (33E) in a downstream direction extends as far as the discharge face (23).

7. Structure (11) according to claim 5, characterised in that the maximum length of the downstream region (33E) of strong adhesion to the joint (17) is less than or substantially equal to the minimum length of the adjacent regions (35C; 35K, 35G) of weak or zero adhesion to the joint (17).

8. Structure (11) according to claim 5, characterised in that the downstream region (33E) extends on the first face (24A).

9. Structure (11) according to claim 5, characterised in that one of the first and second lateral faces (24A, 24B) comprises, between the upstream region (33A) and the downstream region (33E), at least an intermediate region (33J) of strong adhesion to the joint (17), and adjacent regions (35C, 35K) of weak or zero adhesion to the joint (17), located upstream and downstream of the intermediate region (33J), respectively.

10. Structure (11) according to claim 9, characterised in that the lengths of the downstream region (33E), the upstream region (33A) and the intermediate region (33J) are substantially identical.

11. Exhaust line (13), characterised in that it comprises a structure (11) according to claim 1.
